(19) United States
(12) Patent Application Publication
(10) Pub. No.: US 2012/0257544 A1
(43) Pub. Date: Oct. 11, 2012

(54) CONFIGURATION SPACE FEEDBACK AND OPTIMIZATION IN A SELF-CONFIGURING COMMUNICATION SYSTEM

(75) Inventors: Brett Schein, San Jose, CA (US); Yashwanth Hemaraj, Milpitas, CA (US); Murari Srinivasan, Palo Alto, CA (US)

(73) Assignee: SPIDERCLOUD WIRELESS, INC., Santa Clara, CA (US)

(21) Appl. No.: 13/440,763

(22) Filed: Apr. 5, 2012

Related U.S. Application Data
(60) Provisional application No. 61/472,130, filed on Apr. 5, 2011.

(51) Int. Cl. H04W 84/18

(52) U.S. Cl. 370/255

(57) ABSTRACT

Methods, devices, and computer program products facilitate proper allocation of network resource in a self-configuring network. The initial configuration space associated with the self-configuring network is updated based on information received from the network that describes particular adequacies or inadequacies of the initial configuration space. Based on the received information, the configuration space is updated to accommodate proper and efficient operations of the network.

### CROSS-REFERENCE TO RELATED APPLICATIONS

This application is a non-provisional patent application based on U.S. Provisional Patent Application No.: 61/472,130, filed Apr. 5, 2011, which is incorporated herein in its entirety.

### FIELD OF INVENTION

The present invention relates generally to the field of wireless communications. More particularly, the present invention relates to dynamically modifying the configuration space of self-configuring wireless communication systems.

### BACKGROUND OF THE INVENTION

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In cellular networks, radio nodes, also sometimes referred to as base stations, access points, Node Bs, eNode Bs, cells and the like, are normally installed and commissioned after a careful upfront planning and survey process, which is followed by extensive post installation optimization efforts to maximize the network performance. Such optimization efforts usually involve a considerable amount of manual intervention that could include “drive testing” using specialized measurement devices to collect data on network performance at a variety of geographical locations. This data is then post-processed and analyzed to effect optimization steps including power adjustments, antenna tilt adjustments and the like. As a result of such elaborate network planning and optimization operations, the exact number of operating radio nodes, the coverage area of each radio node, the transmit power levels, and other parameters associated with the network is determined and fine-tuned.

In a small-cell (e.g., local area) networks that are installed and operated relatively inexpensively, such expensive planning and post-installation fine tuning of the network is not economically feasible. For example, such installation procedures may be prohibitive in enterprise networks, as well as applications that relate to high-density capacity enhancements of a downtown city square and ad-hoc deployment of a cellular network such as in military applications. Nevertheless, proper configuration and optimization of such networks is important for enabling efficient utilization of network resources. In order to properly allocate the necessary resources for operation of the network, configuration settings must be selected from within a set of configuration parameters. The size of the configuration space is typically set arbitrarily by a human operator without having a detailed knowledge of the radio frequency (RF) characteristics of the deployment area, the exact number of radio nodes and other network information. Therefore, the allocated configuration space may be too large or too small, which can lead to inefficient use of network resources, interference in uplink and downlink communications and problems associated with handoff operations.

### SUMMARY OF THE INVENTION

The disclosed embodiments relate to methods, devices, and computer program products that enable optimization of the configuration space in a network.

According to one aspect of the invention, there is provided a method that includes provisioning a self-configuring communication network in accordance with a configuration space, producing feedback information indicative of the sufficiency of the configuration space, determining whether the configuration space is sufficient based on the feedback; and if the configuration space is determined to be insufficient, updating the configuration space based on the feedback.

According to another aspect of the invention, there is provided a device that includes a processor, and a memory comprising processor executable code, the processor executable code, when executed by the processor, configures the apparatus to:

provision a self-configuring communication network in accordance with a configuration space,produce feedback information indicative of the sufficiency of the configuration space, determine whether the configuration space is sufficient based on the feedback, and if the configuration space is determined to be insufficient, updating the configuration space based on the feedback.

According to yet another aspect of the invention, there is provided a computer program product, embodied on a computer readable medium, comprising:

program code for provisioning a self-configuring communication network in accordance with a configuration space,program code for producing feedback information indicative of the sufficiency of the configuration space, program code for determining whether the configuration space is sufficient based on the feedback, and if the configuration space is determined to be insufficient, program code for updating the configuration space based on the feedback.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates an exemplary network within which the disclosed embodiments can be implemented;

FIG. 2 illustrates an exemplary network within which the disclosed embodiments can be implemented;

FIG. 3 illustrates an exemplary network within which the disclosed embodiments can be implemented;

FIG. 4 illustrates another exemplary network within which the disclosed embodiments can be implemented;

FIG. 5 is a block diagram illustrating operations that are conducted for optimization of configuration space in accordance with an example embodiment;

FIG. 6 is a simplified diagram that illustrates multi-tier neighbors in a cellular network; and

FIG. 7 is a block diagram of an example device for implementing the various disclosed embodiments.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner. Further, some of the disclosed embodiments are described in the context of an enterprise network. However, it should be understood that the disclosed principles are equally applicable to other types of networks.

Some smaller scale cellular networks, including femtocells and enterprises networks, utilize self-configuration and self-organizing techniques that are based on on-going measurements of the RF environment to obtain the network topology. For example, see U.S. patent application Ser. No. 12/957,181, entitled “METHOD, SYSTEM AND DEVICE FOR CONFIGURING TOPOLOGY OF A WIRELESS NETWORK,” filed Nov. 30, 2010, and assigned to the present assignee. This application is hereby incorporated by reference in its entirety. Additionally, large-scale networks may also utilize self-configuration and self-organizing techniques that are based on on-going measurements of the RF environment to obtain the network topology, in accordance with the embodiments of the invention described herein.

Self-configuring networks must select their configuration settings from within a configuration space (i.e., a set of self-configurable parameters that are allowed to take on a limited set of values). For example, the network may be allowed to self-configure the transmit power of each radio node within the range 0 dBm and 10 dBm. As another example specific to Universal Mobile Telecommunication System (UMTS), the network may be allowed to self-configure the primary scrambling code (PSC) associated with each radio node using a set of allowable PSC's. The configuration space is often set by an operator. For example, a network operator may set the configuration space to restrict radio node transmit powers within the range 0 dBm and 10 dBm, and PSC's values within the range 200 to 209. As another example, a network operator may set the configuration space to restrict PSC's values to a list of ranges and/or singletons. In an example specific to Long Term Evolution (LTE), various other parameters such as the physical cell ID (PCI), neighbor relations, maximum down link cell or eNodeB power, the reference or pilot signal power, or down link channel bandwidth may be self-configured.

When setting up the configuration space for a self-configuring network, the operator generally does not want to maximize the size of the configuration space. For example, allowing a large maximum transmit power level can potentially allow the self-configuring network to cause excessive interference in the local macro network. In another example, allowing a large set of allowable PSCs can lead to excessive interference and/or a potential to cause ambiguity that leads to handoff problems. Such ambiguity and/or interference can be caused due to the use of identical PSCs by independent self-configuring networks that are within communication range of the self-configuring network, the macro network, or a set of autonomous home Node-B's. The potential for ambiguity associated with assigning a large number of PSCs can be further illustrated in an example scenario where a user within a macro cell reports a particular PSC as being “strong” or desirable for handoff purposes. If the PSC is reused within multiple, independent self-configuring networks deployed around that macro cell, there is an ambiguity as to which cell the reported PSC refers to. On the other hand, allocating a small range of assignable PSCs can also lead to excessive interference due to PSC reuse within the self-configuring network, as well as potential delays in establishing communication sessions within the self-configuring network.

When deploying a self-configuring network, the operator may not be fully aware of the detailed topology and RF propagation environment of the network. Therefore, the operator is often unable to set up a configuration space of proper size, which can lead to unpredictable network performance problems. For example, to reduce downlink interference and to avoid handoff problems, every radio node within a local area should have a unique PSC. At the time of network deployment, the operator does not know the RF characteristics of the deployment and is thus unaware of the exact number of radio nodes within the local area. The operator may also not be aware of the particular scrambling codes used by other networks, such as home NodeB's or other femtocells that are operating in the vicinity of the self-configuring network. Therefore the operator is not be able to predict the appropriate range of PSC's that must be included in the configuration space.

The disclosed embodiments enable automatic and dynamic allocation of the configuration space for self-configuring networks. The disclosed embodiments rely on the feedback that is received from one or more entities within the self-configuring network to discern whether or not the configuration space, or portions thereof, is suitable for efficient operation of the network. In response, the configuration space is automatically adjusted to accommodate the needs of the self-configuring network. The configuration space can include a variety of parameters, and the associated ranges, that facilitate proper operation of the network. By the way of example, and not by limitation, the configuration space parameters include a range of transmit power levels associated with radio nodes, a minimum assignable transmit power level for each radio node, a maximum assignable transmit power level for each radio node, cell, and/or NodeB or eNodeB (for TR-196 self-configuration object, there can be assigned a minimum value and a maximum value for maximum assignable transmit power level), a set of assignable primary scrambling codes or physical cell IDs (PCI), a set of channels (e.g., Universal Terrestrial Radio Access Absolute Radio Frequency Channel Numbers (UARFCN)) or E-UTRA Absolute Radio Frequency Channel Numbers (EARFCN) available for use by the network, one or more cell identifiers (CID) to identify the cells within a radio network subsystem (RNS), a radio network controller identifier (RNCID), which may be used in conjunction with the CIDs, a maximum uplink transmit power value to be used by the user equipment in the network, minimum and maximum downlink power values associated with a primary common pilot channel (PCPICH) in UMTS systems or reference signal in LTE, a femto access point (FAP) Coverage Target value, which defines the target value for the range of a FAP's downlink coverage in terms of RF propagation loss, the download channel bandwidth in LTE, and the like. It should be also noted that one or more of the configuration space parameters may be presented as a range of values, rather than a single value. For example, the maximum uplink transmit power for each user equipment may be specified as a range of maximum transmit power values (e.g., a lower and an upper maximum transmit power value), in which the lower bound on the maximum transmit power may be used to ensure a minimum coverage area for a cell. As another example, the downlink transmit power for each user equipment may be specified as a range of downlink transmit powers.

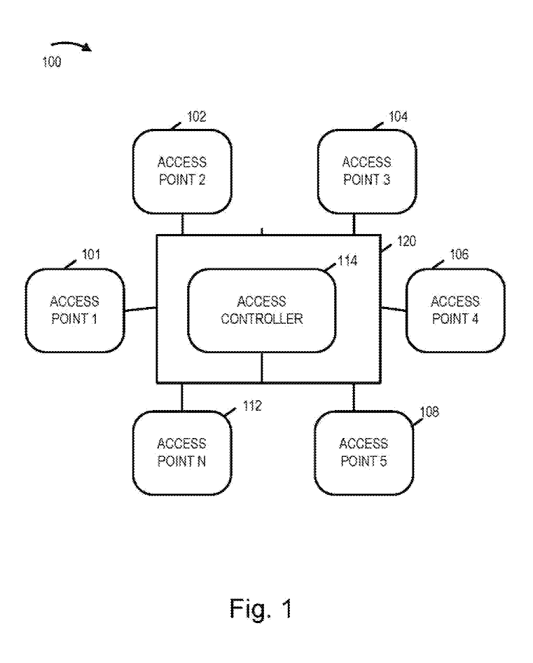

FIG. 1 illustrates an exemplary system 100 which may be used to accommodate some or all of the disclosed embodiments. The system 100 can, for example, be a self-configuring enterprise network. The system 100 includes a plurality of access points referenced as 101, 102, 104, 106, 108 and 112. The access points that are illustrated in FIG 1 are connected, directly or indirectly, to an access controller 114 through connection 120. Each of the access points 101, 102, 104, 106, 108 and 112 is herein referred to as an “internal access point” (or an “internal radio node”). Each internal access point may communicate with a plurality of user equipment (UE), as well as other access points. It should be noted that while FIG. 1 illustrates a single central controller 114 that is distinct from the access points, it is also possible that the access controller is implemented as part of one or more access points. Further, the various embodiments of the present invention may also be implemented using a peer-to-peer network of access points, where each access point can initiate certain transmissions, including commands and/or data, to other access points without the involvement of a central controller.

The exemplary block diagram that is shown in FIG. 1 is representative of a single network that may be adjacent to, or partially overlapping with, other networks. The collection of these other networks, which may comprise macro-cellular networks, femtocell networks and the like, are herein referred to as the external networks. Each “external network” may comprise one or more access controllers and a plurality of “external access points” (or “external radio nodes”).

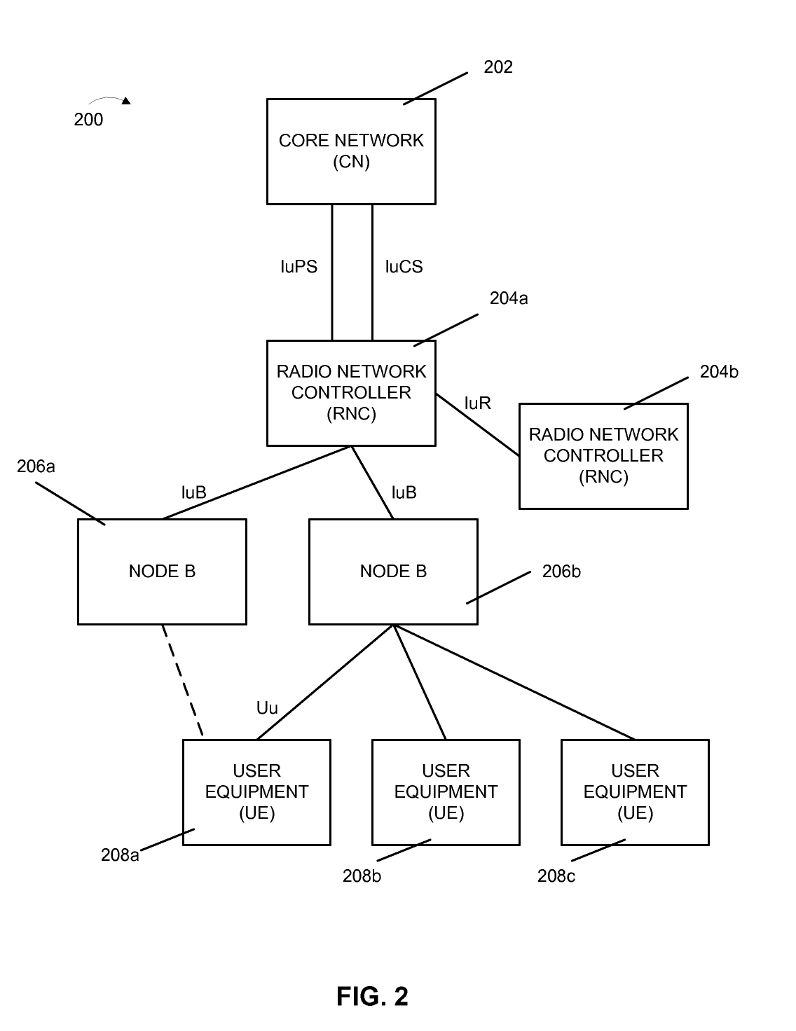

FIG. 2 is another exemplary diagram of a radio network 200, such as a Universal Mobile Telecommunication System (UMTS) Terrestrial Radio Access Network (UTRAN), that can accommodate the various disclosed embodiments. The network that is depicted in FIG. 2 comprises a Core Network (CN) 202, one or more Radio Network Controllers (RNC) 204a that are in communication with a plurality of Node Bs 206a and 206b (or base stations or radio nodes) and other RNCs 204b. Each Node B 206a, 206b is in communication with one or more UEs 208a, 208b and 208c. There is one serving cell controlling the serving radio link assigned to each UE 208a, 208b and 208c. However, as illustrated in FIG. 2 with a dashed line, a UE 208a may be in communication with more than one Node B. For example, a Node B of a neighboring cell may communicate with one or more UEs of the current cell during handoffs and/or to provide overload indications. While FIG. 2 depicts an exemplary UMTS radio network, the disclosed embodiments may be extended to operate with other systems and networks such as CDMA2000, WiMAX, LTE and the like.

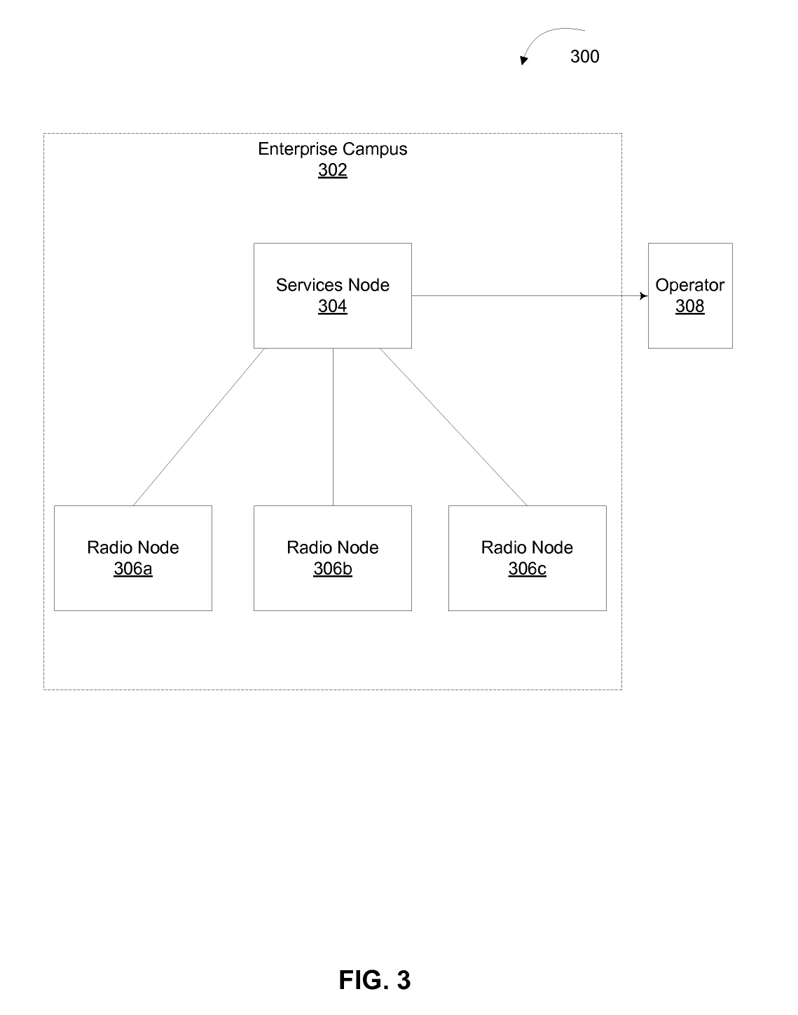

FIG. 3 illustrates an exemplary Enterprise Radio Access Network (E-RAN) 300 that can be used to accommodate the various disclosed embodiments. The E-RAN 300 includes a services node 304 and a plurality of radio nodes 306a, 306b and 306c. It should be noted that the E-RAN 300 can include fewer or additional radio nodes and/or additional services nodes. The services node 304 is the central control point of the overall cluster of radio nodes 306a, 306b and 306c that are deployed throughout the enterprise campus 302. In some embodiments, the services node 304 is operationally equivalent to the access controller 114 that is depicted in FIG. 1. The services node 304, which can be deployed inside the enterprise local area network (LAN) provides, for example, session management for all mobile sessions delivered by the radio nodes 306a, 306b and 306c. Each of the radio nodes 306a, 306b and 306c may be in communication with one or more UEs (not depicted). The radio nodes 306a, 306b and 306c can support a multi-radio architecture that allows a flexible upgrade path to higher user counts, as well as the ability to support different radio access technologies. In one example, the E-RAN 300 configuration allows the creation of a unified mobile corporate network that integrates mobile workers distributed throughout the overall enterprise domain with centrally located corporate assets. FIG. 3 also illustrates an operator 308 that is in communication with the services node 304, which can monitor the operations of the services node 304 and can provide various input and control parameters to the services node 304. For example, the operator 308 can setup configuration space parameters for the enterprise campus 302. The interactivity between the operator 308 and the services node 304 can be provided through, for example, a command line interface (CLI) and/or industry-standard device configuration protocols, such as TR-69 or TR-196. It should be noted that while the exemplary diagram of FIG. 3 illustrates an operator 308 that is outside of the enterprise campus 302, in some embodiments, the operator 308 can reside within the enterprise campus 302.

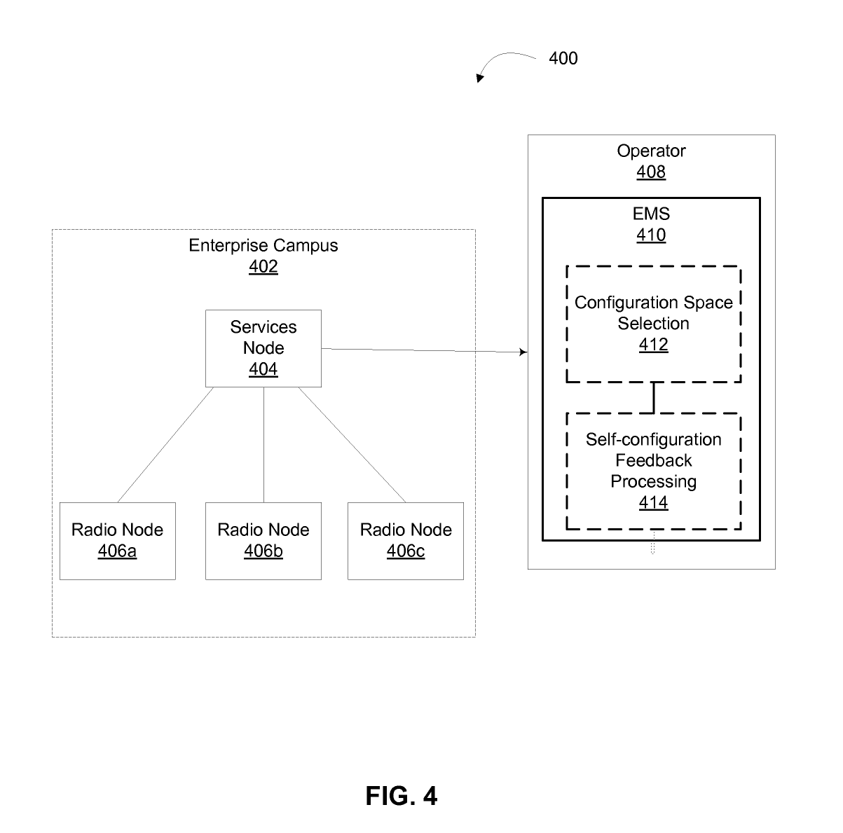

FIG. 4 illustrates another exemplary Enterprise Radio Access Network (E-RAN) 400 that can be used to accommodate the various disclosed embodiments. This embodiment also includes a services node 404 in communication with a plurality of radio nodes 406a, 406b, and 406c deployed throughout the enterprise campus 402. In this embodiment, the operator 408 includes an Element Management System (EMS) 410. The EMS 410 can include a Configuration Space Selection Module 412 and a Self-Configuration Feedback Processing Module 414. The EMS 410 can be configured to receive configuration space warnings from the E-RAN 400 and use the Configuration Space Selection Module 412 to update the configuration space accordingly. Alternatively, the EMS 410 can be configured to receive self-configured parameters from the E-RAN 400 and use the Self-Configuration Feedback Processing Module 414 to process the information to determine itself that the configuration space is adequate or inadequate. Information can be pushed to the EMS 410 by the E-RAN 400 or sent upon request from the EMS 410. By way of example, and not by limitation, the E-RAN 400 could send the EMS 410 the list of internals cells, their self-configured chosen primary scrambling codes, their chosen transmit powers, their neighbor scan results, their constructed neighbor lists, and the like. As another example, the E-RAN 400 could send user equipment measurement reports to the EMS 410 including that appropriate coverage cannot be met with the given cell power assignments, or as another example, by any allowable cell power assignments.

It should be noted that while the exemplary radio networks that are depicted in FIGS. 1-4 all include a central controller, the disclosed embodiments are equally applicable to non-centralized network architectures. Such architectures can, for example, comprise isolated home Node Bs, radio nodes and/or a femtocell-based enterprise deployments that do not use a central controller.

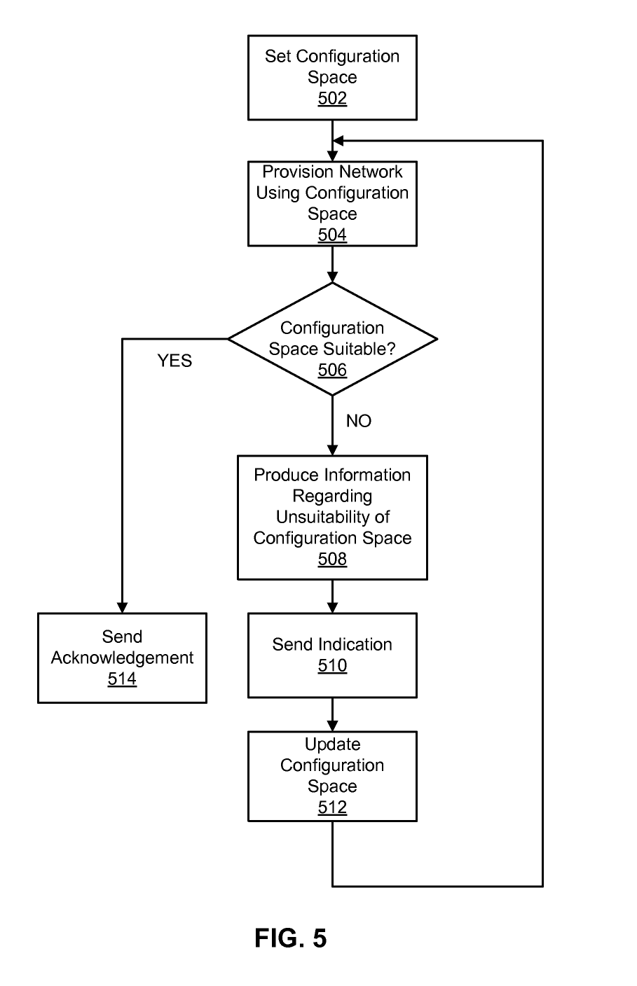

FIG. 5 is a block diagram that illustrates some of the operations that are conducted to produce an optimized configuration space for a self-configuring network according to the disclosed embodiments. In step 502, the configuration space is initially set up. For example, an operator may provide an initial configuration space based on his/her best guess estimates of the range of required resources, prior experience and other factors. As depicted in, for example, FIG. 3, the interactivity between the operator 308 and the network (e.g., the enterprise campus 302) can be provided through, for example, a command line interface (CLI) and/or carried out using particular protocols, such as the ones described by TR-69 or TR-196. Similarly, as depicted in, for example, FIG. 4, the interactivity between the EMS 410 and the network (e.g. the enterprise campus 402) can be provided through, for example, a command line interface (CLI) and/or carried out using particular protocols, such as the one described by TR-69 or TR-196.

In step 504, the self-configuring network is provisioned within the configuration space that was set up in step 502. For example, by reference to FIG. 3, the information regarding the configuration space can be received by the services node 504 and used to allocate transmit power levels, assign PSCs, and allocate other system resources. In step 506, the network determines if the configuration space is suitable for enabling efficient operation of the network. If the answer is “yes,” no more actions are needed. However, in some embodiments, the process continues to step 514, where an acknowledgment is sent to the operator to confirm the suitability of the current configuration space. The confirmation may include additional feedback, such as an indication that the configuration space for some parameters is larger than needed. Alternatively, with reference to FIG. 4, self-configured parameters may be processed by the Self-configuration Feedback Processing Module 414 of the EMS 410 to determine if the configuration space is suitable for enabling efficient operation of the network. The word “provisioning” and “provision” as described herein denotes setting the configuration space and configuration elements for a network. It is the network operator communicating with the access controller on the management interface: creating logical radio nodes, cells, services node(s), and setting configuration parameters (CS domain information, PS domain information, AAA information, policy information, etc.), including the self-configuration configuration space. By way of example, the self-configuration configuration space would include things such as maximum allowable cell transmit power=X, minimum allowable cell transmit power=Y, the set of assignable DL PSCs={p1,p2,p3,p4, . . . }, etc.

As noted earlier, it is possible that the initial configuration space is not suitable for the self-configuring network. For example, the self-configuring network 300 or EMS 410 may determine that the set of assignable PSCs or PCIs is too small because the same PSC or PCI has to be assigned to two radio nodes that are first- or second-tier neighbors of each other. The suitability determination may be based on measurements and information of external network cells as well as internal network cells and user equipment. For example, the determination that the assignable PSC or PCI values is too small may in part include the detection of overlapping PSCs or PCIs used by neighboring external cells. As a result, a radio node can have two neighboring radio nodes with the same PSC or PCI, which can cause both interference and handoff problems.

It can be learned and reported when PSCs or PCIs are reused too closely through UE feedback. For example, in a UMTS system, the UE reports a PSC. When an attempt to add a link is made, it can be determined that it was added on an incorrect self-configuring radio node/NodeB based on timing or radio link sync failure. In another scenario, a UE reports a PSC and a Cell ID. A problem can be detected if the E-RAN knows that there is another Cell with the same PSC but a different Cell ID in the same area, perhaps through a previous scan or through a UE reporting the same PSC with a different Cell ID in the past. In an LTE system, the UE reports a PCI. When an attempt to add a link is made, it can be determined that it was added on an incorrect LTE cell/eNodeB based on timing or radio link sync failure. In another scenario, when the UE reports a PCI, the E-RAN asks the UE to decode and report the E-UTRAN Cell Global Identifier (ECGI). A problem can be detected if the E-RAN knows of another Cell with the same PCI but a different ECGI in the area, perhaps through a previous scan or through a UE reporting the same PCI with a different ECGI in the past.

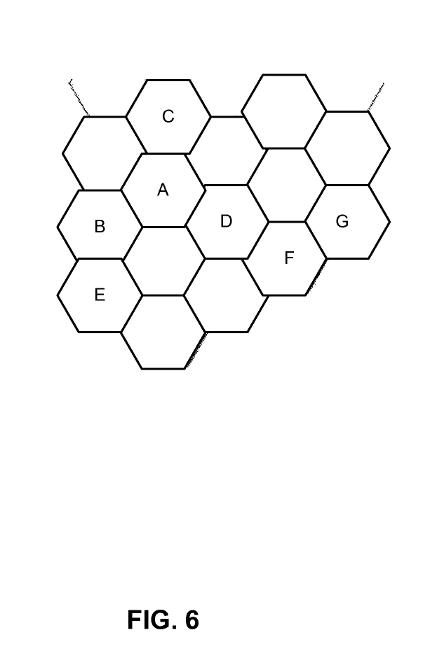

The concept of multi-tier neighbors can be explained by reference to the simplified depiction of FIG. 6. Let's assume that, when radio node A is in operational mode, it can be discovered by radio nodes B, C and D. In this case, radio node A is the first-tier neighbor of radio nodes B, C and D and, by reciprocity, each of the radio nodes B, C and D are first-tier neighbors of radio node A. Let's further assume that during the discovery process conducted by the self-configuring network, radio node E is discovered by radio node B, radio node F is discovered by radio node D, and radio node G is discovered by radio node F. In such a scenario, radio node E, is the first-tier neighbor of radio node B, and a second-tier neighbor of radio node A. Further, radio node F is a first-tier neighbor of radio node D, and a second-tier neighbor of radio node A. Finally, radio node G is a first-tier neighbor of radio node F, a second-tier neighbor of radio node D, and a third-tier neighbor of radio node A. It should be noted that in FIG. 6, for the sake of simplicity, the coverage area associated with the various nodes are depicted as non-overlapping hexagonal blocks. However, in other examples, the coverage areas of the radio nodes may be overlapping and/or have different shapes.

By way of example, and not limitation, various other things can be learned and reported that might be relevant for self-configuration of the network. For example, it can be learned and reported when the self-configuring radio nodes (NodeBs or eNodeBs) are too far away from each other. This could be based on when detected signal strengths are determined to be too weak during scan operations or when self-configured neighbor lists or neighbor relations are too spare. Similarly, it can be learned and reported when self-configuring radio nodes (NodeBs or eNodeBs) are too close to each other. This could be based on when detected signal strengths are too strong during scan operations. It is also possible to determine when the load across networks cannot be balanced. This could indicate that an additional radio node or physical change of radio node locations might be helpful.

Referring back to FIG. 5, if, in step 506, the configuration space is determined not to be suitable, the network 300 or Self-configuration Feedback Processing Module 414 of the EMS 410, in step 508, produces information that indicates the current configuration space is not suitable for the self-configuring network. In one example, the produced information includes different levels of warnings based on the severity of configuration space problems. In another example, the produced information includes details regarding when, where and why such configuration problems were encountered.

TABLE 1
Example Indications Produced in Step 408

| Warning | | | |
|---|---|---|---|
| Level | Reason | Relevant Entities | Action Needed |
| Severe | Same PSC is | Nodes A, B and C | Increase PSC range |
| | assigned to first- | | |
| | tier neighbors | | |
| Moderate | Same PSC is | Nodes B and C | Increase PSC range |
| | assigned to | | to include N |
| | second-tier | | additional PSCs |
| | neighbors | | |
| Low | Same PSC is | Nodes G and E | Increase PSC range |
| | assigned distant | | from 200-209 |
| | neighbors | | to 200 to 212 |
| Low | Too many PSCs | N/A | Decrease PSC range |

Table 1 provides examples of the information that may be produced in step 508. It should be noted that the exemplary listings of Table 1 are only produced to facilitate the understanding of the underlying concepts, and additional or fewer information may be produced in step 508 of FIG. 5. Table 1 indicates that the information produced in step 508 can include multi-level warnings. For example, a severe warning may be produced due to an assignment of the same PSC to two first-tier neighbor radio nodes. The information that is produced in step 508 can also identify the particular entities that are affected. For example, the severe warning that is listed in Table 1 affects radio nodes A, B and C (see FIG. 6 for an exemplary depiction of radio nodes). A moderate warning may be produced if, for example, the same PSC is assigned to two second-tier neighbors. In such a case, the information that is produced in step 508 can, for example, identify nodes B and C as being affected by the insufficiency of PSC range. Table 1 also indicates that a low warning level may be produced if the same PSC is assigned to distant neighbors associated with the network, or if the PSC range is too large and thus exceeds the needs of the current network. The information that is produced in step 508 can also include recommendations (or specific commands) as to how the configuration space needs to be modified. As provided in the exemplary listings of Table 1, these recommendations can include general instructions (e.g., increase/decrease PSC range) and/or more specific commands (e.g., increase PSC range to include N additional PSCs or increase PSC range from 200-209 to 200 to 212).

After the generation of the information in step 508 of FIG. 5, some or all of the information is communicated to the operator 308 or the Configuration Space Selection Module 412 of the EMS 410 in step 510. In one possible implementation, the operator 308 or EMS 410 can pull the information from the network. For example, the information can be stored on the Services Node in the form of conditions, warnings, or operational state information, and the like, whereby the operator can check and pull the information as necessary. In another possible implementation, some portions of the information can be both pulled by the operator 308 or EMS 410 and other portions of the information can be communicated (i.e., “pushed”) to the operator 308 or EMS 410. In such an implementation, according to one example embodiment, the operator 308 or Configuration Space Selection Module 412 may configure an Alarm that triggers when the self-configuring network assigns the same PSC to 1^{st} tier neighbors. If the self-configuring network decides it has to assign the same PSC to 1^{st} tier neighbors, it could send an indication similar to the one described in Table 1 row 1, above. As noted earlier, the operator 308, 408 can include a human operator and/or an interface that is capable of receiving manual and/or automated instructions from a hardware or software entity. The operator can also automatically or manually update the configuration space based on the received instructions or recommendations. In one embodiment, the operator comprises an automated provisioning system (APS) that is capable of provisioning the self-configuring network without human interaction. The operator may also have the computational capabilities needed for computing the necessary modifications to the configuration space. In addition, the operator is capable of communicating, directly or indirectly, with the various entities associated with the self-configuring network, such as controllers, radio nodes and/or user equipment, as well databases and computer storage media. Such communications may be carried out using a variety of wired and/or wireless techniques.

Once the produced information is communicated to the operator 308 or Configuration Space Selection Module 412, the configuration space is updated in step 512. The updated configuration space can then be communicated to the network (not shown), where it is used to modify the existing system resource allocations to accommodate the network requirements. In one example, the updated configuration space can be communicated to a central controller associated with the self-configuring network (e.g., to the services node 304, 404 depicted in FIGS. 3 and 4). In another example, the updated configuration space is stored at a storage media that is subsequently accessed by the network to obtain the updated information.

After receiving and/or accessing the updated configuration space, the process returns to step 504, where the network is reconfigured based on the updated configuration space. The process that is describes in steps 504 to 510 can continue until an optimized configuration space is produced. In some embodiments, the reconfiguration of a self-configuring network may further trigger a self-configuration process in another self-configuring network. For example, the feedback may indicate that a first self-configuring network needs a larger set of PSCs. After the first self-configuring network iterates with the new configuration space, a neighboring self-configuring network may need to scan its environment to discover the new PSC assignments for its neighbors. In one example, the operator may trigger the self-configuration of the neighboring network to occur.

In the context of the block diagram of FIG. 5, in one example embodiment, step 502 may be skipped all together. Instead, the self-configuring network can perform a topology discovery scan to determine the characteristics of the radio nodes within, and/or neighboring, the self-configuring network. For example, during the topology discovery, a radio node can be placed in operational mode while all other radio nodes are placed in monitoring mode in an attempt to detect the operating radio node. Further details regarding topology discovery techniques for self-configuring networks can be found in U.S. patent application Ser. No. 12/957,181, entitled “METHOD, SYSTEM AND DEVICE FOR CONFIGURING TOPOLOGY OF A WIRELESS NETWORK,” filed Nov. 30, 2010, which is assigned to the present assignee. In one example, the operator may not even include an initial set of PSCs. Rather, a topology discovery operation can produce an indication of the number of, for example, PSCs needed for adequate configuration of the network. Pursuant to the topology discovery operation, an indication can be produced to indicate that, for example, 15 PSCs are needed to configure the network. The operator may then enter 15 or greater assignable PSCs into the configuration space, which allows the network to subsequently assign PSCs to the cells from the new configuration space. It should be noted that, during the topology discovery phase, the network can obtain the number of PSC's that is needed to achieve no PSC reuse, no PSC reuse for second-tier neighbors, no PSC reuse for first-tier neighbors, and the like. The network can also identify the set of external PSC's in use by external radio nodes, and avoid using those PSCs in the network configuration space. Similar determinations as to the minimum and maximum power levels, channel numbers and other configuration space parameters can be made during the automated topology discovery.

In some embodiments, the power level assignment for each radio node (e.g., the minimum and maximum transmit power level) may be modified based on long-term assessments of the RF environment by the radio nodes of the self-configuring network. For example, each radio node may conduct periodic RF measurements that can be analyzed to determine the presence of “coverage holes” and/or excessive interference from neighboring radio nodes. In this context, rather than immediately reporting an adequacy or inadequacy of the transmit powers to the operator, the process that is depicted in FIG. 5 can remain at step 504 until the self-configuring network has gathered sufficient information over time. In response to these measurements, the transmit power associated with one or more radio nodes may be increased or decreased to attain optimum coverage. In one example, UE measurements are received from the internal cells and external cells and a determination can be made as to whether to increase or decrease transmit powers in order to meet a coverage target. In situations where the optimum target coverage cannot be attained, the operator may be alerted. In other example embodiments, the inadequacy of the power assignment range may be indicated after processing UE measurement reports that are gathered as users utilize the communication system over time. In these example embodiments, the inadequacy is determined by calculating cell downlink pathlosses to those UE measurement points and determining that the coverage target cannot be met when constrained to the configured maximum cell powers. The above noted embodiments may further be extended by including uplink considerations. For example, the inadequacy can also be determined by first calculating uplink pathlosses from those UE measurement reports, and then comparing the result with an uplink target received signal power or SNR, and also comparing the results with the configured maximum uplink transmit power for UEs. Inadequacy can be indicated if the maximum uplink transmit power minus uplink pathlosses cannot achieve the target received signal power or target received SNR at the cells.

In other example scenarios, an indication regarding adequacy/inadequacy of a first portion of the configuration space is produced at a different time than an indication regarding adequacy/inadequacy of a second portion of the configuration space. For example, an indication regarding the inadequacy of the number of PSCs may be sent immediately after configuration of the network with an initial (or updated) set of PSCs, while an indication as to the inadequacy of maximum transmit power levels may be triggered after several iterations of power measurement/adjustment by the self-configuring network. Using this technique, unnecessary updates to the configuration space due to transient network conditions are also avoided.

Configuration space updates can also be triggered by other events and/or observations of the self-configuring network. This can be performed by way of a two-step process. In a first step, the observations may first trigger a reconfiguration of the self-configuring network. This could be autonomous (self-configuring network just goes ahead and reconfigures itself). This could be an indication to the operator that it should reconfigure itself, and the operator then indicates that it should reconfigure itself. In a second step, when the self-configuring network attempts to reconfigure itself, in the process it learns that its current configuration space is insufficient. From that, it will follow the steps shown in FIG. 5. This may be the typical approach when something changes in the environment around the self-configuring network deployment. For example, the operator may install another network nearby or one or more macro cells (or pico cells or femto cells) around the deployment configuration space. In some embodiments, handoff failure events or call failure events (e.g., voice or data sessions) can be used to initiate a configuration space update. For example, the self-configuring network can learn over time that there is a high frequency of handoff failures or dropped calls in the vicinity of particular radio nodes and, subsequently, alert the operator as to the observed problems. The self-configuring network may also provide suggestions for mitigating the problems, such as increasing the upper bound on maximum cell power (for the whole network or for particular radio nodes) or deploying additional radio nodes at the problematic locations.

As also indicted by the last entry of Table 1, the self-configuring network or Self-Configuration Feedback Processing Module can determine that the configuration space is larger than what is needed for efficient operation of the network and, accordingly, notify the operator. For example, the self-configuring network or Self-Configuration Feedback Processing Module may determine that an original set of 30 PSCs is larger than necessary to meet a target goal, and the network only needs 20 PSCs achieve a suitable configuration.

While some of the exemplary embodiments have been described in the context of a self-configuring and self-optimizing wireless network that utilize one or more central controllers, it is understood that the disclosed embodiments are equally applicable to networks without a central controller (e.g., an autonomous collection of femtocells). In a de-centralized network, direct radio node-to-radio node communications (over the air or through a wired communication link) may be carried out to assess the suitability of the configuration space, and to provide the pertinent information for mitigating the shortcomings of the configuration space to an operator. In such de-centralized architectures, the radio nodes have the capability to conduct various scans and measurements, analyze the results of the scans and measurements, and communicate the result to one or more other radio nodes and/or to the operator. Similarly, the disclosed embodiments can be applied to hybrid systems that utilize both a central controller and peer-to-peer radio node communications.

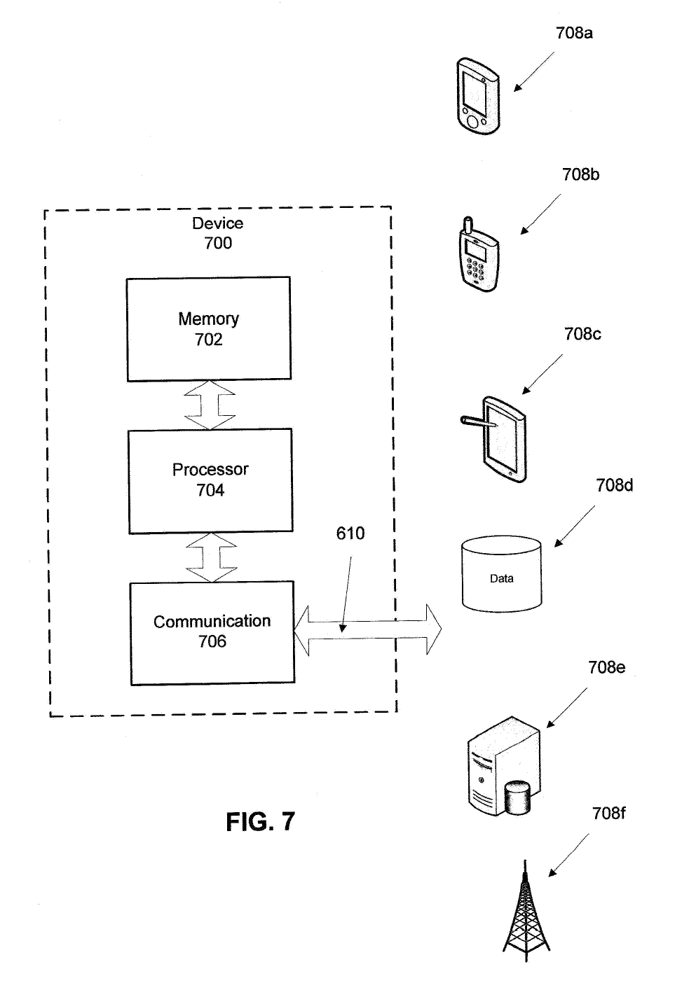

It is understood that the various embodiments of the present invention may be implemented individually, or collectively, in devices comprised of various hardware and/or software modules and components. These devices, for example, may comprise a processor, a memory unit, an interface that are communicatively connected to each other, and may range from desktop and/or laptop computers, to consumer electronic devices such as media players, mobile devices and the like. For example, FIG. 7 illustrates a block diagram of a device 700 within which the various embodiments of the present invention may be implemented. The device 700 comprises at least one processor 704 and/or controller, at least one memory 702 unit that is in communication with the processor 704, and at least one communication unit 706 that enables the exchange of data and information, directly or indirectly, with other entities, devices and networks 708a to 708f. For example, the device 700 may be in communication with mobile devices 708a, 708b, 708c, with a database 708d, a server 708e and a radio node 708f. The communication unit 706 may provide wired and/or wireless communication capabilities, through communication link 710, in accordance with one or more communication protocols and, therefore, it may comprise the proper transmitter/receiver antennas, circuitry and ports, as well as the encoding/decoding capabilities that may be necessary for proper transmission and/or reception of data and other information. The exemplary device 700 that is depicted in FIG. 7 may be integrated as part of the various entities that are depicted in FIGS. 1-4, including an access controller 114, an access point 101, 102, 104, 106, 108 and 112, a radio node controller 204a and 204b, a Node B 206a and 206b, a user equipment 208a, 208b and 208c, a services node 304, 404, a radio node 306a, 306b, 306c, 406a, 406b, and 406c and/or an operator 308, 408. The device 700 that is depicted in FIG. 7 may reside as a separate component within or outside the above-noted entities that are depicted in FIGS. 1-4.

The various components or sub-components within each module of the disclosed embodiments may be implemented in software, hardware, firmware. The connectivity between the modules and/or components within the modules may be provided using any one of the connectivity methods and media that is known in the art, including, but not limited to, communications over the Internet, wired, or wireless networks using the appropriate protocols.

Various embodiments described herein are described in the general context of methods or processes, such as the processes described in FIG. 5 of the present application. It should be noted that processes that are described in FIG. 5 may comprise additional or fewer steps. For example, two or more steps may be combined together. The disclosed methods may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the disclosed embodiments can be implemented as computer program products that reside on a non-transitory computer-readable medium. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. For example, the disclosed embodiments are equally applicable to networks that utilize different communication technologies, including but not limited to UMTS (including R99 and all high-speed packet access (HSPA) variants), as well as LTE, WiMAX, GSM and the like. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
provisioning a self-configuring communication network in accordance with a configuration space; and
producing feedback information indicative of the sufficiency of the provisioned configuration space;
determining whether the configuration space is sufficient based on the feedback; and
if the configuration space is determined to be insufficient, updating the configuration space based on the feedback.

2. The method of claim 1, further comprising
receiving the updated configuration space in response to the produced feedback information; and
reconfiguring the self-configuring communication network in accordance with the updated configuration space.

3. The method of claim 1, wherein the configuration space is produced, at least in-part, pursuant to a topology discovery operation conducted by the self-configuring communication network.

4. The method of claim 1, wherein the configuration space comprises an initial set of parameters that are further refined in accordance with a topology discovery operation conducted by the self-configuring communication network.

5. The method of claim 2, wherein reconfiguration of the self-configuring communication network triggers self-configuration of another self-configuring communication network.

6. The method of claim 4, wherein
the initial set of parameters comprises an initial set of primary scrambling code (PSC) values; and
the topology discovery operation produces an indication as to the number of PSCs needed for configuration of the self-configuring communication network.

7. The method of claim 1, wherein:
at least an initial parameter associated with the configuration space is obtained pursuant to a topology discovery operation conducted by the self-configuring communication network; and
an operator assigns a value associated with the range of the initial parameter in accordance with the results of the topology discovery operation.

8. The method of claim 1, wherein the configuration space is produced by an operator of the self-configuring communication network.

9. The method of claim 1, wherein at least a portion of the information is produced substantially immediately after configuring the self-configuring communication network.

10. The method of claim 1, wherein at least a portion of the information is produced pursuant to a plurality of measurements after configuring the self-configuring communication network.

11. The method of claim 10, wherein the plurality of measurements are conducted by an entity selected from the group consisting of:
a user equipment external to the self-configuring network;
an entity internal to the self-configuring network.

12. The method of claim 1, wherein the configuration space comprises parameters that are selected from a group of parameters consisting of:
a range of primary scrambling codes;
a set of primary scrambling code values;
a range of transmit power levels for downlink and/or uplink transmissions;
a minimum transmit power level;
a maximum transmit power level;
a cell identifier (CID);
a radio network controller identifier (RNCID);
a downlink power value associated with a primary common pilot channel (PCPICH);
a femto access point (FAP) coverage target value; and
a set of channels.

13. The method of claim 1, wherein the produced information comprises an indication selected from a group of indications consisting of:
a multi-level warning;
a reason for a multi-level warning;
a listing of one or more affected entities; and
an instruction for modifying the configuration space.

14. The method of claim 1, wherein the produced information comprises an indication as to an insufficient number of assignable primary scrambling codes or an insufficient transmit power level.

15. The method of claim 14, wherein the produced information comprises an instruction for increasing the number of assignable primary scrambling codes or for modifying a value of the transmit power level.

16. The method of claim 1, wherein the configuration space comprises parameters that are selected from a group of parameters consisting of:
a range of physical cell IDs (PCI);
a set of physical cell ID (PCI) values;
a range of transmit power levels for downlink and/or uplink transmissions;
a minimum transmit power level;
a maximum transmit power level;
a downlink power value associated with a reference signal
a set of channels;
a downlink channel bandwidth; and
an uplink channel bandwidth.

17. The method of claim 1, wherein the produced information comprises an indication as to a larger than necessary configuration space parameter.

18. The method of claim 17, wherein the produced information comprises an instruction for reducing the configuration space parameter.

19. The method of claim 1, wherein the produced information comprises an indication as to an insufficient number of assignable physical cell IDs (PCI) or an insufficient transmit power level and instruction for increasing the number of assignable PCI or modifying a value of the transmit power level.

20. The method of claim 1, wherein the updated configuration space is produced by an operator and communicated to an entity accessible by the self-configuring communication network.

21. A device, comprising:
a processor; and
a memory comprising processor executable code, the processor executable code, when executed by the processor, configures the apparatus to:
provision a self-configuring communication network in accordance with a configuration space;
produce feedback information indicative of the sufficiency of the provisioned configuration space;
determine whether the configuration space is sufficient based on the feedback; and
if the configuration space is determined to be insufficient, update the configuration space based on the feedback.

22. A computer program product, embodied on a computer readable medium, comprising:
program code for provisioning a self-configuring communication network in accordance with a configuration space;
program code for producing feedback information indicative of the sufficiency of the configuration space;
program code for determining whether the configuration space is sufficient based on the feedback; and
program code for, if the configuration space is determined to be insufficient, updating the configuration spaced based on the feedback.
